(19) United States
(12) Patent Application Publication
(10) Pub. No.: US 2006/0179422 A1
(43) Pub. Date: Aug. 10, 2006

(54) Method and apparatus for automated execution of tests for computer programs

(75) Inventor: Georg Gortler, Baiersdorf (DE)

Correspondence Address: SCHIFF HARDIN LLP;Patent Department, 6600 Sears Tower, 233 South Wacker Drive, Chicago, IL, 60606, US

(73) Assignee: Siemens Aktiengesellschaft

(21) Appl. No.: 11/051,356

(22) Filed: Feb. 4, 2005

(51) Int. Cl. G06F 9/44

(52) U.S. Cl. 717/124

(57) ABSTRACT

In a method for the automated execution of tests for computer programs, a test sequence for the computer program is generated from data in a databank and is executed. The databank contains a machine-readable description of a function of the computer program to test.

### BACKGROUND OF THE INVENTION

1. Field of the Invention

The present invention concerns a method and a device for the automated execution of tests for a computer program.

2. Description of the Prior Art

Extensive tests are necessary for the implementation of computer programs. During the execution of tests computer program errors are recognized and can be corrected prior to the delivery to customers. Computer programs are subject to: careful testing, especially for the control of imaging diagnostic devices, since computer program errors can under certain circumstances pose a danger to patients. Computer programs serving to control a magnetic resonance apparatus generally include a number of subprograms that control individual components of the magnetic resonance apparatus, and in turn are controlled by a number of call parameters. Since direct control of the magnetic resonance apparatus via subprograms would be uncomfortable for a user, the computer program generally includes a user interface. Numerous operating elements for the control of the magnetic resonance apparatus are available at the interface. An examination of the patient is controlled using the operating elements, for example. The user interface starts a corresponding subprogram with appropriate call parameters. The user communicates with the subprograms solely via the user interface.

Computer program errors can occur in any component thereof, including the subprograms and the user interface. It is especially undesirable or even dangerous, if, for example, the user interface, due to an error, accesses the wrong subprogram. It is necessary for a tester to execute all subprograms with all possible combinations of call parameters and the reactions of the magnetic resonance apparatus are evaluated and recorded for a complete test of the computer program. Additionally the dependencies between different calls among subprograms must be tested as to correct implementation. The execution of one subprogram that requires interaction with another may occur in the calibration of a magnetic resonance apparatus. Added thereto is a test of the user interface that is employed. Due to the multiplicity of possible tests, it is nearly impossible for the tester to cover all parameter combinations and calls within the tests. All risks therefore, cannot be completely eliminated.

The tests of the user interface can be partially automated. A tester tending to the operating elements of the user interface can be simulated via Mercury's program WinRunner®. WinRunner® executes the operations of a tester automatically. However, it is necessary to assemble a script via which WinRunner® is controlled. Listed therein, for example, are the operating elements. WinRunner® also needs information about the position and type of operating elements as well. The assembly of such a script is very extensive, especially in the case of complex user interfaces.

### SUMMARY OF THE INVENTION

An object of the present invention is to provide a method with which automated computer program tests can be executed extensively.

The object is solved by a method according to the invention wherein a test sequence is generated from data stored in a databank that contains a machine-readable description of the computer program's function. Subsequently said test sequence is executed automatically on a computer. By mean of the description of the computer program's function contained in the databank it is possible to automatically generate and execute the test sequence.

A reference against which the computer program is tested is needed for testing. Hence a part of the data describes specified functions in the preferred embodiment of the invention during the conceptions phase of the computer program. Whether all specified conceptions phase computer program functions are properly executed thus can be established.

The data of the databank exists in the standardized meta-language XML according to a preferred embodiment of the invention. Thus a universal implementation of the method is ensured.

The test workflow is generated by means of a test case generator via an XSL transformation from the data in the databank in an advantageous embodiment of the invention. This has the particular advantage, that the test sequence via such stipulated transformations as the data can be transferred to other formats, thus the test sequence is available in a desired format.

Since a complete test even via automated execution would occupy time, the user, in another embodiment of the invention, can establish the scope of the test to be executed. The test thus can be adapted flexibly to the respective needs. For example, it is possible, after a new implementation of a part of the computer program to subject only this part to a test.

At least one test case embodies the test sequence in the preferred form of the invention. Independent parts of the computer program can be tested in succession in an automated test sequence without intervention of the user by partitioning of the test sequence into test cases.

The user interface is tested in the preferred embodiment of the invention.

In another embodiment of the invention the test of the user interface is executed via WinRunner®. From the data of the databank a script for WinRunner® can be generated via an XSL transformation by the test case generator. WinRunner® simulates a user of the user interface, by activating operating elements of the user interface, and fills out input fields according to the script. The user interface is especially easily tested in this way.

Computer programs generally have a number of subprograms. For instance, in a control program for a magnetic resonance apparatus individual functions are controlled via subprograms. By using variable call parameters the functions of the magnetic resonance apparatus are directly influenced. Since errors, particularly in subprograms designed to control a magnetic resonance apparatus pose a danger to the patient, in a preferred embodiment of the invention a subprogram is tested via a test workflow. The test workflow represents one test case and contains at least one call of the subprogram.

In another embodiment of the invention a number of subprograms are tested in succession via a test workflow, and started therein with different call parameters. A high testing coverage is achieved easily in this way.

For instance, during operation of the computer program the execution of a workflow of the control of a magnetic resonance apparatus occurs. This includes a sequence of calls of subprograms using their respective call parameters. In so far as these resemble the test workflows, however, the workflows are modeled such that meaningful utility of the magnetic resonance apparatus is possible.

In another embodiment of the invention a test report is generated from protocols of the individually executed test cases and is depicted on a display medium. The user can view the results in a simple way and, in the event of existing computer program errors, take corresponding action.

### DESCRIPTION OF THE DRAWINGS

FIG. 1 is a schematic process diagram of a preferred embodiment of the invention for testing a control program for a magnetic resonance apparatus.

FIG. 2 is a flowchart for the execution of the method of FIG. 1.

FIG. 3 illustrates a user interface.

### DESCRIPTION OF THE PREFERRED EMBODIMENTS

In the following a method designed to test a computer program is explained as an exemplary embodiment, wherein the computer program serves to control a magnetic resonance apparatus.

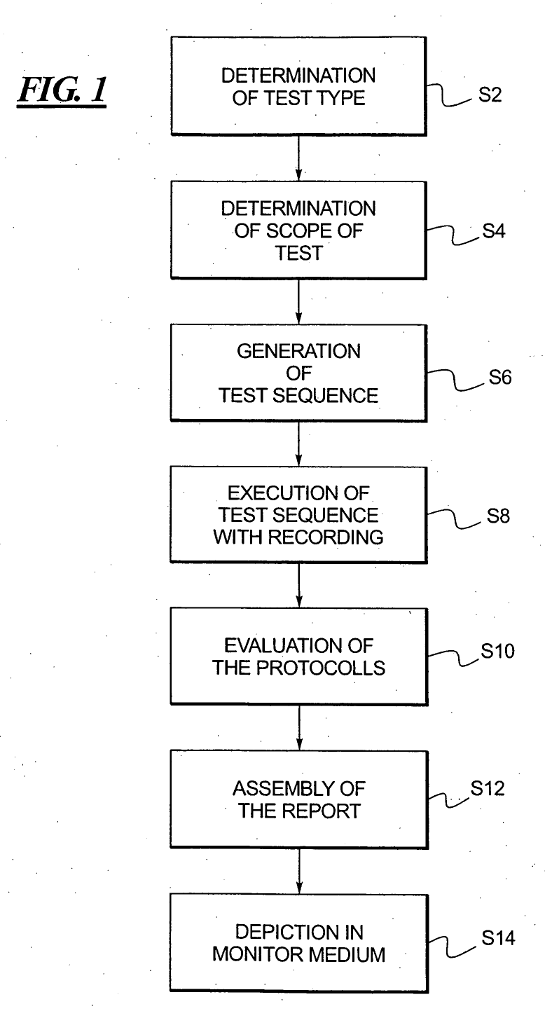

In the first method step S2 the type of test to be executed is determined according to FIG. 1. A number of types of tests are possible. For example, it is possible to test individual subprograms of the computer program. This is necessary after a reprogramming of :subprograms to uncover errors occurring at implementation, for example. A subprogram of the computer program for the operation of a magnetic resonance apparatus is designed for compensation of eddy currents, for instance. Eddy currents in the resulting magnetic fields of a magnetic resonance apparatus can be lessened or eliminated by an execution of the subprogram. Call parameters for the subprogram matching the respective situation are necessary for this. It is important to test as many combinations of call parameters as possible to uncover errors in the execution of a test of the subprogram.

In a further type of test it is possible to test the user interface. Therewith all depicted operating elements are tested for proper function. The user interface serves to control workflows of the magnetic resonance apparatus by the user. A workflow serves to utilize the magnetic resonance apparatus and includes a sequence of calls from subprograms with specified call parameters. There are a number of workflows, such as, for example, calibration or the execution of measuring processes. At the user interface the different operating steps of a workflow to be executed are listed in order of execution. Depending on the choice of the operating step, using a mouse, for instance, configuration possibilities for the operating step are given to the user. The user can choose, for example, which coil and which gradient the compensation should be executed in the operating step for compensation of eddy currents. The subprogram is then given the respective call parameters via the user interface and the compensation is executed. It is important that, in the execution of the workflow, the user can only make permissible” adjustments. To mitigate malfunctioning of the magnetic resonance apparatus or damage to the magnetic resonance apparatus especially in a direct input of number values, the values have to be limited to permissible values. In a test all input and output fields possible on the user interface should be tested with all possible parameters in order to recognize an occurrence of errors.

A third type of test is a test of dependency between different operating steps, respectively the calls of subprograms. It is possible that the execution of one operating step requires the operating step execution of another prior in the magnetic resonance apparatus. It is also possible as well that the execution of one operating step requires the repeated execution of another operating step. So, for example, after shimming the magnetic resonance apparatus, an adjustment of the resonance frequency is necessary, even if it was already set prior to shimming. For the operation of a magnetic resonance apparatus it is necessary for the computer program to reliably recognize that type of dependencies and to impede operating errors.

The three described types of tests can be respectively executed as integrated tests or unit tests. The interplay between the user interface and a given subprogram is tested in the integration test. For this purpose the subprograms are activated by a transfer of call parameters from the user interface and tested for error-free operation. The unit test tests the user interface by itself or subprograms individually. The subprogram is executed with all possible combinations of call parameters. At the user interface all operating elements are utilized and all adjustment possibilities are tested.

An additional executable type of test concerns the interactive help of the computer program. For example, in every user interface there is a push button that, upon activation, opens a help window for the respective user interface. There is a dynamic (HTML-based) description of the executable workflow and the individual operation steps of the respective user interface produced from data in the databank. Possible dependencies to operating steps not depicted are also included. It is important for the test to determine whether the correct help window is opened with respect to the user interface.

After selection of one of the available types of tests, the user can establish the extent of the executable test in method step S4. It is possible, for example, to execute all of the computer program's executable operating steps with all possible combinations of calls of all subprograms with usage of all permitted combinations of call parameters and user interfaces. It is also possible, for example, to individually test parts of a newly programmed subprogram.

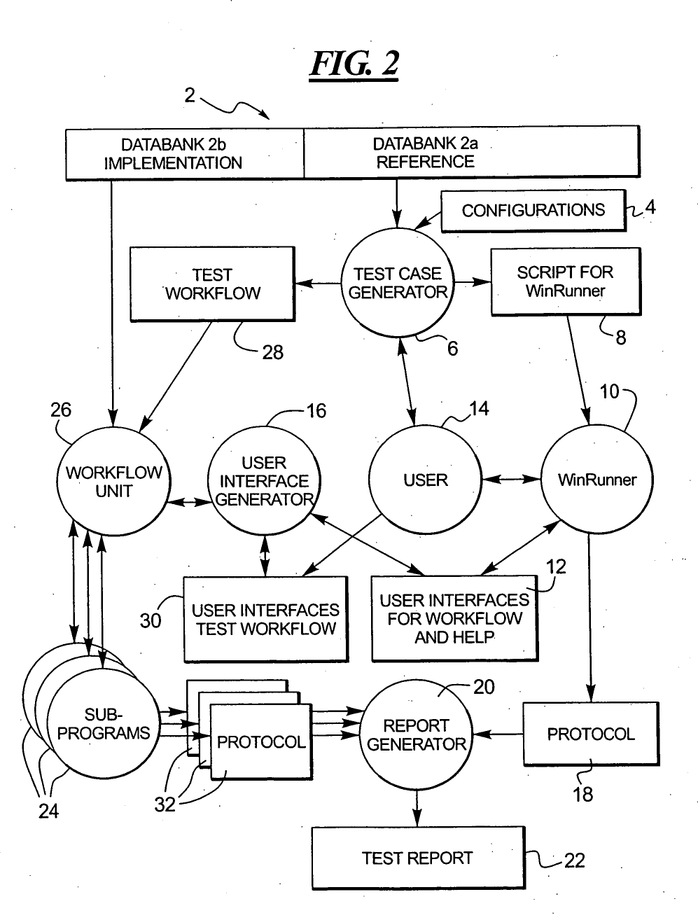

In a third method step S6 a corresponding test sequence is generated. The test sequence in general includes a number of test cases in each of which for example a subprogram or a user interface is tested. The number of test cases corresponds with the given scope of the test. A description of the function of the computer program in the databank is used at the generation of test cases. All possible operating steps of the computer program, all subprograms and user interfaces as well as all workflows are stored in XML format in the databank. Test cases are produced via an XSL transformation from the data in the databank corresponding to the previously established type of test and the desired scope of the test. The test cases form the test sequence. The databank is described in further detail via FIG. 2 below.

In a fourth method step S8 the test sequence is executed. There are two possibilities to differentiate. The test cases are produced as script data for Mercury company's WinRunner® for the test of the user interface and the integration test in which user interfaces are involved. WinRunner® simulates a use of the user interface with the script established parameters in lieu of a user, which takes place fully automatically and therefore with huge time savings. Testing of the help utility is executed via WinRunner® and the contents of the generated help windows are evaluated. It can thus be ensured that the correct help is depicted for every user interface.

A test workflow is executed via a workflow unit for testing subprograms. For this purpose, corresponding data from the databank are modified via an XSL transformation to form the test workflow. In comparison to a workflow, the test workflow does not necessarily include reasonable sequences of operating steps for the utilization of a magnetic resonance apparatus. In a test workflow, a subprogram can be started multiple times with different combinations of call parameters that for instance would not be generally sensible in an application of the magnet resonance device during a patient's examination. Moreover, test workflows are generated according to a given test type and scope of the test while the workflows are largely predetermined. Fundamentally the workflow as well as the test workflow comprises the call of one or more subprograms with call parameters.

In the execution of test workflows an influencing possibility is given to the user in that the test workflow is initially generated and is graphically depicted in a user interface which is generated by a user interface generator. Here the user can limit, for example, the usable parameters or exclude individual subprograms from the test.

The execution of test cases is automatically protocolled in both cases, either as tests executed by WinRunner® or per workflow unit, and resultant values, such as error messages are summarized in a protocol. An evaluation of the protocol follows in a fifth method step S10. Therein, for example, resultant values concluding a successful execution of the subprograms are rejected. Then, in the sixth method step S12, a test report is assembled containing, for example, only error-ridden execution steps of the test. In a seventh method step S14 the test report is depicted on a visual medium, such as a monitor, for instance. The user can evaluate the test report and test results and initiate corresponding measures, for example, elimination of the found errors in the implementation of subprograms.

It is equally important to test the respective operating elements of the user interface and the workflow in the completely assembled product. WinRunner® is utilized with the corresponding scripts generated from XML data and description of the interfaces. A workflow and an associated user interface are generated via the workflow unit and the user interface generator, analogously to the aforementioned embodiment. The workflow is simulated by the WinRunner® execution and a corresponding protocol is conducted.

All tests can be executed with a real magnetic resonance apparatus. The interplay between a real magnetic resonance apparatus with an actual implementation of the computer program designed to control said device is thereby tested. Should the respective computer program be universally applied to numerous different models of magnetic resonance apparatuses it is necessary to take into account the actual configuration of the particular magnetic resonance apparatus for the generation of test cases. For example, the different magnetic resonance apparatuses may differ in the design of the gradient system. The gradient strength as well as the maximum rate of change in the gradient fields of different devices may thereby differ. It is necessary at the generation of the test sequence of the computer program to take into consideration all device configurations and to generate corresponding test cases. The adjustable parameters for the test workflows for the subprograms to be tested, as well as the user interfaces that contain specific elements corresponding to respectively equipped magnetic resonance apparatuses, differ between different models. In this respect, the test workflows (executed by the individual work flow components) and integration and user interface tests executed by WinRunner® are dependent upon the respective device configuration.

It is possible to test the computer program while simulation software simulates a magnetic resonance apparatus. Therein, for given calls of subprograms or commands from the operating elements, simulated values of the magnetic resonance apparatus are returned to the respective subprograms, alternatively to the user interface.

FIG. 2 clarifies the above-described method in a schematic depiction of the participating components. The links between individual components are symbolized by arrows. Unidirectional arrows indicate, for instance, a unidirectional connection between two components in one direction. Double arrows indicate that the data exchange between components occurs in both directions. For a better understanding, data generated in the generation and execution of a test sequence, for instance test cases, are also depicted. Additionally a user is shown schematically.

One of the components is a databank 2, having two parts 2a and 2b. Within a conception phase of the computer program the desired functionality of the computer program is specified and corresponding data are stored in a first part 2a of databank 2. The test sequence is later generated from this data. The corresponding, data for the actual implementation of the computer program to be tested are stored in the second part 2b of the databank 2. The data include descriptions of configurations, subprograms, user interfaces, workflows and the interactive help. The functionality of the computer program is completely stored in the databank 2.

The data of databank 2 exist in a standardized meta-language. In the exemplary embodiment the language is XML. It is, however, possible to use other Meta-languages, SGML for instance. Descriptions of all parts of the computer program, especially all subprograms and workflows exist in the databank 2. Not only a content but also a meaning to be associated is achieved via the XML characteristic of the data, with which the type of the existing data can be clearly identified. For instance, it is clearly determined which data within the databank 2 carry a description of a function of the subprograms or parameters for a subprogram. Additionally, explanations of individual program parts for which the respective help pages can be generated are identifiable. Furthermore, the databank 2 contains information about possible workflows. Via the characteristics of the stored data in databank 2, these are machine-readable and, for example, can be evaluated by computer program.

In an additional databank 4 all possible configurations of magnetic resonance apparatuses that are serviceable via the computer program are stored. This offers the advantage that different computer programs built to control a number of magnetic resonance apparatuses could be tested. In databank 4, for instance, the names of different magnetic resonance apparatuses as well as the respective strength of the main magnetic fields and the capacity of the gradient systems are stored.

A further component is attest case generator 6, connected to the first part 2a of the databank 2. The test case generator 6 generates a test sequence containing one or multiple test cases via an XSL transformation from the data of databank.2. Different given configurations of magnetic resonance apparatuses in databank 4 can be thereby allowed for. The test case generator 6 is also linked to databank 4 to allow access to possible configurations. Via XSL transformation, it is possible to generate other data formats or to choose specific data and restructure it from XML data. The test case generator 6 generates scripts 8 for WinRunner® 10 from the fundamental XML data from databank 2, the scripts 8 being capable for use for unit/component tests or integration tests of the user interface 12. The data necessary for the respective test case are read from databank 8 and converted into a script 8 via XSL transformation. The script 8 contains operating instructions allowing WinRunner® 10 to operate the user interface 12 and simulate a user. Moreover, WinRunner® 10 needs a description of the respective user interface 12 to be tested, wherein the positions of the operating elements contained in the user interface 12 are depicted. Additionally the possible values of the operating elements must be given. These can be, for example, check boxes with the values “on” or “off” or, given call of the subprograms, can be a parameter range for a call parameter. The subsequent test can be fully automatically performed via the particular script 8 for WinRunner® 10 that contains the specific test case and as well a description of the user interface 12 and is automatically drawn from XML data. A user 14 can interact with the test case generator 6 and choose then to which extent to test.

A user interface generator 16 that serves to produce the user interface 12 to be tested by WinRunner® 10 is described further below.

By means of the script 8 produced by the test case generator 6, WinRunner® 10 activates the user interface 12, by the parameter combinations determined by script 8 being entered and pushbuttons pressed. Here too the user 14 has the possibility for direct interaction via WinRunner® 10. The user can, for example, start WinRunner® 10 with a delay. The automated tests can be run on a real magnetic resonance apparatus at night, for example when the magnetic resonance apparatus will not be used.

WinRunner® 10 generates protocol data 18 for all executed actions that is evaluated later in a report generator 20, and a test report 22 is assembled. The test report 22 is posted for the perusal of the user 18 on a monitor screen.

User interfaces 12 generated for the execution of workflows can be tested via WinRunner® 10 for errors in implementation. It is also possible to execute integration tests via WinRunner® 10. The interplay of the respective user interface 12 with the subprogram to be called is tested. Different combinations of call parameters are transferred to the subprogram and the reaction of the magnetic resonance apparatus is recorded. It is especially important to determine whether every interaction with the user interface 12 affects the results specified in the databank 2. An integration test can include all possible calls for an individual subprogram from different user interfaces 12. It is thereby tested whether the subprogram is correctly called by the corresponding user interfaces 12. This is especially necessary after a modification of or new implementation of the user interface 12.

The interactive help that is assigned to every user interface 12 is tested per WinRunner® 10 as well. Every user interface.12 of the respective workflow includes a button, the activation of which opens an additional window in which a description of the respective workflow and participating subprograms are presented. WinRunner® 10 tests every user interface 12 as to whether this help page displays the correct information respective to the workflow.

Numerous adjustment steps are needed for the adjustment of a magnetic resonance apparatus. It is especially important to implement the dependencies between different steps error-free so that errors do not occur at calibration. That is why it is necessary to test dependencies between individual operations steps that are executed in workflows. For example, a readjustment of the frequency of the RF generators of the magnetic resonance apparatus is necessary after a change in the correction of the homogeneity of the magnetic field. In testing particular dependencies between operating steps of the magnetic resonance apparatus, it is necessary to test that dependencies within one workflow are recognized correctly to make possible the error-free operation of a magnetic resonance apparatus. For example, after the execution of every operating step it is tested whether via this step, other operating steps became necessary. If this is the case, then the user interface generator 16 generates a new user interface 12 which will reference this state and offer to immediately execute the respective operating step even if it was not previously displayed. This type of test is also via WinRunner® 10 and executes respective scripts 8.

In addition to the user interface 12, the computer program to be tested has a number of subprograms 24 as well. These serve for a real interaction with the magnetic resonance apparatus and are activated via the user interface 12. The subprograms can, for instance, be implemented via the command line in the programming language C.

While the integration tests and the unit tests of the user interfaces 12 are executed via WinRunner® 10, individual unit tests of subprograms 24 are undertaken via a workflow unit 26. Test workflows 28 of the subprograms are assembled via the test case generator 6. This concerns sequences of call of subprograms 24 that do not necessarily have to be suitable for a sensible task or work with the magnetic resonance apparatus. A test workflow 28 can, for instance, subsequently activate a subprogram 24 multiple times and at every activation transmit other call parameters. This is, for example, necessary upon the new implementation of individual subprograms 24 to ascertain the absence of errors. In contrast to this in a test of workflows, the sequence of calls of subprograms is structured as with an actual activation of a magnetic resonance apparatus. The workflows exist in the second part 2b of the databank 2 and are adapted to the respective implementation of the computer program. The test workflows 28 are generated via an XSL transformation for the data of the first part 2a of databank 2. The corresponding data are transformed in another XML format, the test workflow 28 exists in an XML format as well.

The workflow unit 26 serves to execute workflows as well as test workflows 28. It relates to data directly from of the second part 2b of databank 2, in which the actual implementation of the computer program to be tested is described. Additionally, the test case generator 6 generates test cases in the form of test workflows 28 that are supplied to the workflow unit 26 as well. The workflow unit 26 transmits detail from the data of the second part 2b of databank 2 to the user interface generator 16, which, via an XSL transformation generates a user interface 12 respectively 30 in the form of HTML data depicted within a web browser. The user interface 12 generated as such, serves for execution of the tests executed via WinRunner® 10 that were described previously. In this case, the data of a workflow of the second part 2b of the databank 2 is read via the workflow unit 26 and conveyed to the user interface generator 16.

On the other hand, special user interfaces 30 are generated for the execution of test workflows 28 via the user interface generator 16 via which the user 14 can exert influence over the respective test. Tested subprograms 24 within the test workflow 28 are listed including their parameters in the user interface 30. The user 14 can then, for instance, exclude individual subprograms 24 from a test or limit the testing parameters. The user interface 30 serves to start the test as well. If given corresponding start command by the user 14, the workflow unit 26 takes the respective resulting values of user interface 30 via the user interface generator 16 and directs the test workflow 28. The respective subprograms 24 are thereby activated and started with the specified call parameters. Thereby, for instance, the complete parameter range of a subprogram 24 can be tested within a test workflow 28. The activation of subprograms 24 functions similarly at the execution of integration tests via WinRunner® 10. Here as well the subprograms 24 are activated via the workflow unit 26.

The respective return values and error messages of activated subprograms 24 are saved in a respective protocol 32 and directed to the report generator 20 for evaluation. They exist in XML format as well. Analogously to the evaluation of the executed tests via WinRunner® 10, the protocols 32 are evaluated and a respective test report 22 is assembled. This is depicted on the monitor screen. Once a number of different types of test cases are executed generally in a test sequence to be executed, only one test report 22 is assembled by the report generator 20 and depicted on the monitor.

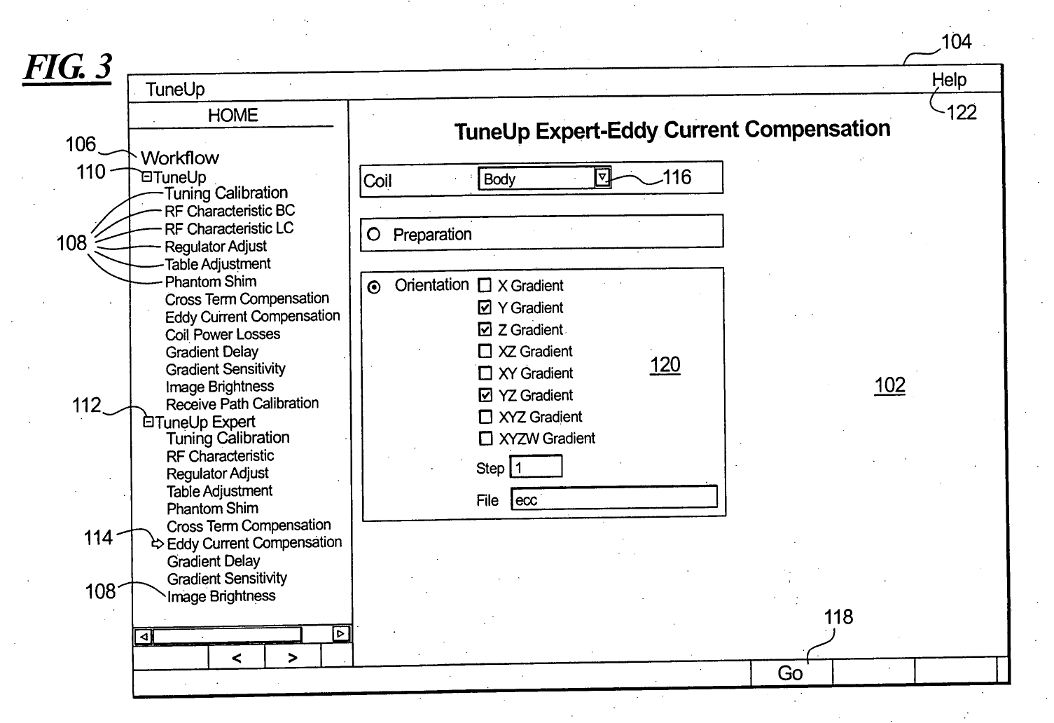

FIG. 3 depicts a representation of a user interface 102 generated by the workflow “Tune-Up”. For the representation of the user interface 102, the respective descriptions from XML data are transferred into HTML data via an XSL transformation that can then be depicted within a web: browser 104. This has the advantage the user interface 102 is viable over multiple platforms. On the left side of the user interface 102, the workflow 106 is depicted as a list of operating steps.108. Differentiation is made between a normal Tune-Up 110 and a version for advanced users (“Tune-Up Expert”) 112. The latter offers experienced users more opportunities for manipulation. Every individual operation step. 108 activates a subprogram 24 and can be chosen by the user. Then the details for the chosen operation step 108 are depicted on the right side of the user interface 102. Eddy currents can be compensated in the shown example in the step “Eddy current compensation” 114 chosen for advanced users. The user can chose which coil will be compensated via the menu 116. In the example, a complete body coil of the magnetic resonance apparatus is chosen. The compensation is executed by activation of respective subprograms that is initiated via a push button (“Go”) 118. Call parameters for the subprograms 24 can be adjusted in the parameter area 120 of the user interface 102. WinRunner® 10 executes these steps during a test. It results in considerable time advantage as WinRunner® 10 can perform the different combinations of call parameters considerably faster than a user. A push button 122 for the activation of help windows is provided in the user interface 102 as well.

A user interface for a test workflow 28 is comparable to one depicted in FIG. 3. The list of operating steps 108 is adapted to the respective test workflow 28. Here the user can influence the test workflow 28 as described above.

A main advantage of the method is the speed with which the tests can be executed. In contrast to the execution of a test by a user, the automated execution of a test can target significantly higher test coverage. For example, after the new implementation of an individual subprogram it is possible in an easy manner to test its integration with the computer program via integration tests and unit tests in workflows and test workflows and uncover errors. By means of the standardized description in XML format, it is possible to assemble test cases based on the fundamentals of the description for functions and to assemble workflows, test workflows, and user interfaces upon this basis. It is basically possible to achieve complete test coverage, to assign all possible parameters to subprograms and start automatically all subprograms in a test workflow it is thereby not necessary, as explained earlier,.for a magnetic resonance apparatus to be linked to computer program. It can be replaced with a simulation computer program. Via the XSL transformation nearly all data can be converted in another data format in another data structure from the XML description of functions. The output data of the XSL transformation scripts or descriptions of test workflows or workflows, available in turn in XML, are thus possible as output files.

The exemplary embodiment has been described herein in the context of a computer program for control of a magnetic resonance apparatus. The inventive method, however, is applicable to a number of other devices controlled via a computer program. It is also possible to test a computer program that does not serve to control a device.

Although modifications and changes may be suggested by those skilled in the art, it is the intention of the inventor to embody within the patent warranted hereon all changes and modifications as reasonably and properly come within the scope of his contribution to the art.

I claim as my invention:

1. A method for automated execution of tests of a computer program, comprising the steps of:
generating a test sequence for testing a computer program from data stored in a databank containing a machine-readable description of a function of the computer program to be tested; and
executing the test sequence automatically on a computer.

2. A method as claimed in claim 1 comprising including, in said description of said function, information designating at least one of operating steps and workflows of said computer program and acceptable values for operational parameters thereof.

3. A method as claimed in claim 1 comprising including in said data stored in said databank, a reference function established during a conception phase of said computer program.

4. A method as claimed in claim 3 comprising including in said data stored in said databank, a description for an implemented function of said computer program.

5. A method as claimed in claim 2 comprising including in each of said workflows several of said operating steps.

6. A method as claimed in claim 2 comprising including, in said data stored in said databank, information designating dependencies between said plurality of operating steps.

7. A method as claimed in claim 2 comprising including, in said data stored in said databank, data representing a description of interactive help for at least one of said operating steps and said workflows.

8. A method as claimed in claim 1 comprising storing said data in said databank with a defined format in a standardized Meta-language.

9. A method as claimed in claim 8 comprising employing XML as said standard Meta-language.

10. A method as claimed in claim 9 wherein said test sequence is generated by a test case generator from said data in said databank via an XSL transformation.

11. A method as claimed in claim 10 wherein said test sequence comprises at least one test case, and each test case is generated by said test case generator.

12. A method as claimed in claim 1 comprising testing a user interface of said computer program via said test sequence.

13. A method as claimed in claim 12 comprising generating said user interface with a user interface generator prior to execution of said test.

14. A method as claimed in claim 12 comprising employing an. HTML interface as said user interface.

15. A method as claimed in claim 14 comprising depicting said user interface via a web browser in communication with said computer.

16. A method as claimed in claim 11 wherein at lease one of said test cases is a WinRunner® script.

17. A method as claimed in claim 16 comprising processing said a WinRunner® script by executing WinRunner®, wherein WinRunner® operates elements of a user interface of said computer program.

18. A method as claimed in claim 11 wherein the step of generating said test cases comprises generating at least one of said test cases as a test workflow by said test case generator.

19. A method as claimed in claim 18 comprising generating each of said test workflows in a standardized Meta-language.

20. A method as claimed in claim 19 comprising employing XML as said standardized Meta-language.

21. A method as claimed in claim 19 wherein said computer program includes a subprogram, and comprising testing said subprogram using one of said test workflows.

22. A method as claimed in claim 21 comprising calling said subprogram using at least one call parameter.

23. A method as claimed in claim 22 comprising repeatedly initiating said subprogram using a plurality of different call parameters.

24. A method as claimed in claim 21 wherein said computer program comprises a plurality of subprograms, and testing each of said plurality of subprograms respectively with said test workflows.

25. A method as claimed in claim 24 wherein said computer program includes a user interface, and comprising executing an integration test as a test case, and respectively testing said subprograms using said integration test by triggers initiated through said user interface.

26. A method as claimed in claim 11 wherein a workflow of said computer program is tested via said test case.

27. A method as claimed in claim 26 wherein said computer program contains at least one subprogram and a user interface, and said workflow contains a sequence of subprogram calls via said user interface.

28. A method as claimed in claim 6 comprising testing said dependencies between said operating steps via said test sequence.

29. A method as claimed in claim 7 comprising testing said interactive help via said test sequence.

30. A method as claimed in claim 1 comprising recording execution of said test sequence in a protocol.

31. A method as claimed in claim 30 comprising generating a test report via said protocol.

32. A method as claimed in claim 1 comprising employing a computer program for controlling a device as said computer program being tested.

33. A method as claimed in claim 32 wherein said device controlled by the computer program has a device configuration, and wherein the step of generating said test sequence comprises generating said test sequence dependent on said device configuration.

34. A method as claimed in claim 32 comprising stimulating said device via a computer program during execution of said test sequence.

35. A method as claimed in claim 32 comprising employing a computer program for operating a magnetic resonance apparatus as said computer program for controlling a device.

36. A computer for automatic execution of tests of a computer program, said computer having access to a databank in which data are stored containing a machine-readable description of a function of the computer program to be tested, said computer being programmed to generate a sequence for testing said computer program from said data stored in said databank containing said machine-readable description of said function of the computer program, and to automatically execute at least one of said test sequence.

37. A test computer program loadable into a computer for automatically executing tests of a further computer program, said test computer program, when loaded into said computer, causing said computer to:
generate a test sequence for testing said further computer program from data stored in a databank containing a machine-readable description of a function of the further computer program to be tested; and
to automatically execute said test sequence in said computer.
